(19) United States
(12) Patent Application Publication
(10) Pub. No.: US 2006/0169393 A1
(43) Pub. Date: Aug. 3, 2006

(54) Method and apparatus for extruding a puncture sealant and mounting on a tire

(76) Inventors: Bina Patel Botts, Cuyahoga Falls, OH (US); Michael Charles Ruegg JR., Akron, OH (US); Brandy Cyan Kohut, Akron, OH (US); Warren Paul Ripple, North Canton, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/315,542

(22) Filed: Dec. 22, 2005

Related U.S. Application Data
(60) Provisional application No. 60/648,329, filed on Jan. 28, 2005.

(51) Int. Cl. B29D 30/00

(52) U.S. Cl. 156/115; 156/123; 152/504

(57) ABSTRACT

A method and apparatus for making a tire with a built in sealant is provided. The method includes the steps of mounting an inner liner onto a tire building drum, extruding a sealant composition into strips having tapered sidewalls, cutting the strip to a desired length, mounting the sealant over the inner liner, and layering one or more tire components over the sealant.

This application claims the benefit of U.S. provisional application No. 60/648,329, filed Jan. 28, 2005.

### TECHNICAL FIELD

This invention relates to a method and apparatus for making and applying a puncture sealant to tire components mounted upon a tire building drum.

### DEFINITIONS

“Aspect” means the of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the crescent—or wedge-shaped reinforcement typically used to reinforce the sidewalls of runflat-type tires; it also refers to the elastomeric non-crescent shaped insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Skive” or “skive angle” refers to the cutting angle of a knife with respect to the material being cut; the skive angle is measured with respect to the plane of the flat material being cut.

“Laminate structure” means an unvulcanized structure made of one or more layers of tire or elastomer components such as the innerliner, sidewalls, and optional ply layer.

### BRIEF DESCRIPTION OF THE DRAWINGS

The structure, operation, and advantage of the invention will become further apparent upon consideration of the following description taken in conjunction with the accompanying drawings wherein:

FIG. 1 is a schematic view of a cross section of tire with sealant;

FIG. 2 is a schematic view of a cross section of the sealant, barrier and innerliner layers.

### DETAILED DESCRIPTION OF THE INVENTION

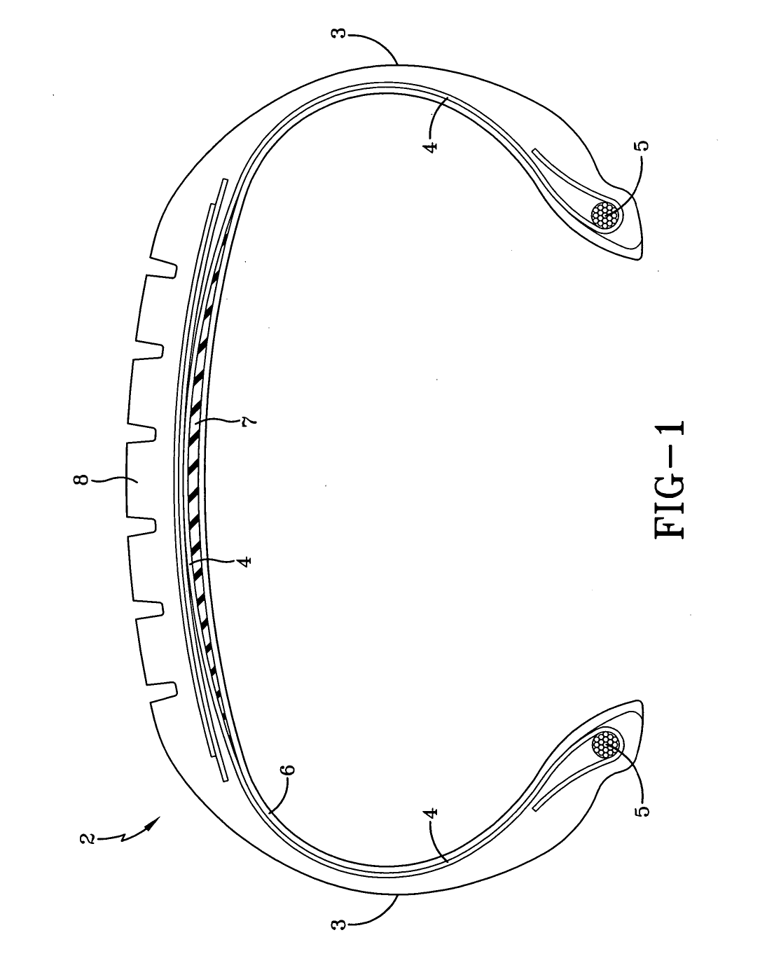

Referring now to FIG. 1, there is illustrated a cross-sectional view of a self-sealing pneumatic tire constructed in accordance with the invention. The tire 2 includes sidewalls 3, a supporting tire carcass 4, a pair of beads 5, an inner liner 6, a sealant layer 7, a barrier layer 9 and an outer circumferential tread 8. The sidewalls 3 extend radially inward from the axial outer edges of the tread portion 8 to join the respective beads. The carcass 4 acts as a support structure for the tread and sidewalls, and is comprised of one or more layers of ply. Sealant layer 7 is shown disposed between the inner liner 6 and a barrier layer 9. The sealant layer 7 may also be disposed at different locations as described in more detail, below. The tread region 8 forms a crown region of the carcass. In the interior region of the tread, there is generally found one or more belts 18. The surface region of the tread forms a tread pattern.

The sealant layer 7 may comprise polymer compositions as described in U.S. Pat. No. 4,895,610, the entirety of which is incorporated by reference. The polymer compositions described therein include the following composition by weight: 100 parts of a butyl rubber copolymer, about 10 to about 40 parts of carbon black, about 5 to about 35 parts of polyisobutylene, about 5 to about 35 parts of an oil extender, about 0 to about 1 part of sulfur, and from about 1 to 8 parts of a peroxide vulcanizing agent. A second polymer composition includes the following composition by weight: 100 parts of a butyl rubber copolymer, about 20 to about 30 parts of carbon black, about 8 to about 12 parts of polyisobutylene, about 8 to about 12 parts of an oil extender, about 0.1 to about 0.4 part of sulfur, and from about 2 to 4 parts of a peroxide vulcanizing agent.

The sealant layer 7 may also comprise a colored polymer composition as described in U.S. pending patent application Ser. No. 10/917,620 filed on Aug. 13, 2004, the entirety of which is incorporated herein by reference. The colored polymer composition is comprised of, based upon parts by weight per 100 parts by weight of said partially depolymerized butyl rubber exclusive of carbon black:
(A) a partially organoperoxide-depolymerized butyl rubber as a copolymer of isobutylene and isoprene, wherein said butyl rubber, prior to such depolymerization, is comprised of about 0.5 to about 5, preferably within a range of from 0.5 to one, percent units derived from isoprene, and correspondingly from about 95 to about 99.5, preferably within a range of from 99 to 99.5, weight percent units derived from isobutylene;
(B) particulate reinforcing filler comprised of:
   (1) about 20 to about 50 phr of synthetic amorphous silica, preferably precipitated silica, or
   (2) about 15 to about 30 phr synthetic amorphous silica, preferably precipitated silica, and about 5 to about 20 phr of clay, preferably kaolin clay, or
   (3) about 15 to about 30 phr synthetic amorphous silica, preferably precipitated silica, and about 5 to about 20 phr of calcium carbonate,
   (4) about 15 to about 30 phr synthetic amorphous silica, preferably precipitated silica, about 5 to about 15 phr of clay, preferably kaolin clay, and about 5 to about 15 phr of calcium carbonate;
(C) from zero to 6, alternately about 0.5 to about 5, phr of short organic fibers
(D) a colorant of other than a black color wherein said colorant is selected from at least one of organic pigments, inorganic pigments and dyes, preferably from organic pigments and inorganic pigments;
(E) from zero to about 20, alternately about 2 to about 15, phr of rubber processing oil, preferably a rubber processing oil having a maximum aromatic content of about 15 weight percent, and preferably a naphthenic content in a range of from about 35 to about 45 weight percent and preferably a paraffinic content in a range of about 45 to about 55 weight percent.

Other sealant polymer compositions which may be utilized by the invention is described in U.S. Pat. No. 6,837,287, the entirety of which is hereby incorporated by reference.

Further, any sealant polymer composition may also be used with the invention that has a polymer composition of butyl rubber and an organoperoxide vulcanizing agent which becomes activated at high temperatures above 100 deg C.

A first embodiment of manufacturing a tire is described as follows. The sealant polymer composition is mixed using a banbury mixer, at an optional remote location from the tire building plant or at the tire building plant. After the polymer composition is mixed, the polymer composition is then milled and formed into sheets of the material, wherein the sheets are separated from each other by silicone coated liners. One example of a silicone coated liner which will separate from the polymer composition is a silicone coated woven fiberglass cloth (coated on both sides of the liner) made by Precision Coating Co., Inc., of Dedham, Mass. and sold under the trade name S/W 10. Another example of a liner which would separate from the polymer composition is a siloxane coated nylon cloth made by Highland Industries.

Next, the sheets of the sealant polymer composition are separated from the liner and fed into one or more mills or heated calender rolls which break down the compound and soften it up by heating. One or more of the mills may be optionally corrugated. The rolls are preferably heated to a temperature sufficient to prevent sticking of the sealant to the rolls. The one or more mills output a continuous strip of sealant polymer composition about 6-10 inches wide.

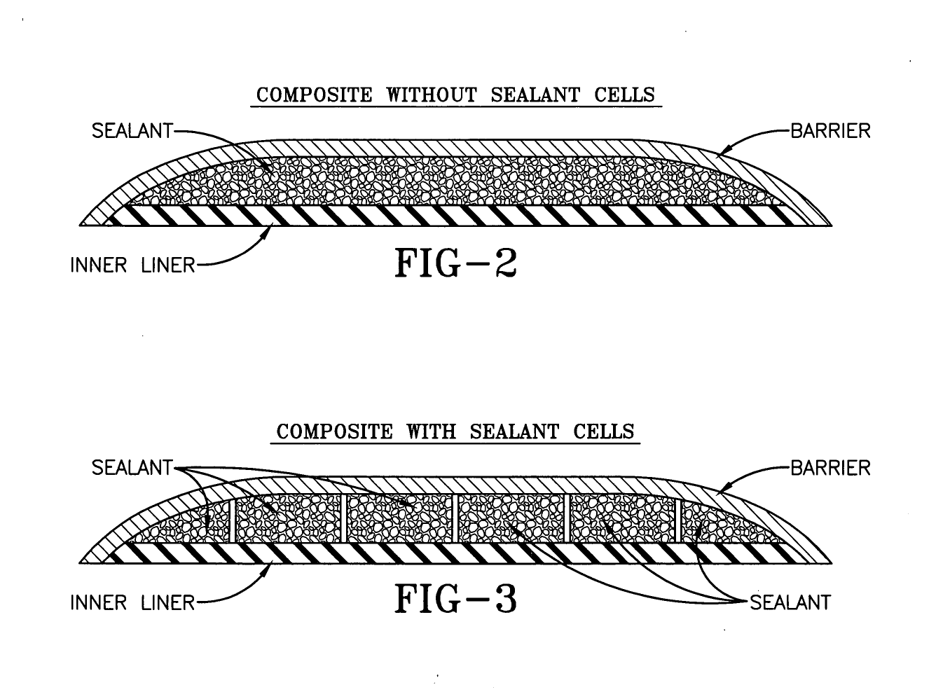

Next the continuous strip of sealant polymer composition is fed strip into a hot feed screw type extruder wherein the sealant polymer composition is heated to about 200 to about 220 deg F., more preferably in the range of about 215 to about 217 deg F. The extruder has a die to form the sealant polymer composition into its final shape, which is shown in FIG. 2. The final shape of the sealant has a cross-sectional shape that has an upper and lower surface that are approximately parallel, with angled or tapered edges. The angle of the tapered edges range from about 15 to about 30 degrees. The uncured width of the sealant is about 6 to about 10 inches or a width sufficient to extend from shoulder to shoulder of the tire. The uncured thickness of the sealant is about 0.25 inches, although the range of the thickness and width can very depending upon the application. The uncured thickness may range from about 0.05 inches to about 0.75 inches. For example, if the sealant is used in a passenger tire, an uncured thickness of about 0.125 inches may be desired, while for a truck tire an uncured thickness of about 0.25 in may be desired.

A cold feed extruder may also be utilized, eliminating the need for preheating of the sealant polymer composition. The internal temperature controls of the cold feed extruder may be utilized to heat the composition in the range of about 200 to about 220 deg F., more preferably in the range of about 215 to about 217 deg F.

The output of the extruder is fed onto a conveyor belt. The extruded sealant polymer composition may then be optionally sprayed with water or cooled gas to cool the sealant polymer composition to below about 100 Deg F.

The extruded sealant may then be cut to length with a heated knife or ultrasonic knife and then the composition may be stored in steel tray storage trucks or bear traps.

During the entire processing of the sealant prior to vulcanization, it is preferred that the temperature of the sealant be below the peroxide activation temperature.

In a second embodiment of the invention, a gear pump extruder may be utilized, eliminating the need for preheating of the sealant polymer composition. Varying the extruder speed can independently control the temperature of the sealant composition. Further, the gear pump is a constant volume device, which will allow application of the sealant composition directly onto the tire building drum. An advantage to the gear pump extruder allows the starting and stopping of the output extrudate without wasting material.

A third embodiment of a manufacturing process for making a tire with a sealant layer is described as follows. First the polymer composition selected for use in the sealant layer 7 is mixed in a banbury mixer. The polymer composition is then fed to an extruder, either a hot feed extruder or a cold feed extruder. The extruder has a screw feed mechanism and a die. The die is shaped to form a cross-sectional shape of the extruded sealant as shown in FIG. 2. The cross-sectional shape of the sealant is approximately an elongated rectangle with angled or beveled outer edges. The strip output from the extruder has a width in the range of about 6 to about 10 inches. The strip is extruded onto a spacer fabric which has spacers on the side of the fabric to ensure that the composition does not get deformed when rolled up and stored on a spool. The spool can then be transported to the tire building drum where the sealant component is cut to the desired length and mounted to the tire.

The sealant layer in all of the above embodiments may be positioned between the innerliner and barrier layer or between the innerliner and carcass. It is preferred that the sealant layer be completely encased or encapsulated between the rubber layers to prevent migration of the sealant. The built-in sealant layer may, for example, be positioned between a tire innerliner rubber layer and tire carcass or between two tire innerliner rubber layers wherein said sealant layer may:(A) extend from one shoulder of the tire to the other through the crown region of the tire; (B) be positioned in at least one tire shoulder area region and extend into at least a portion of the adjoining tire sidewall portion of the tire, or (C) extend from sidewall-to-sidewall through the tire crown region.

When the sealant layer is positioned between a first rubber layer and a second rubber layer, it is preferred that the sealant splice be located at a different location than the splice of the first and second layers. It is also preferred that the sealant splice be stitched before the second rubber layer is added thereon.

The thickness of the sealant composition layer can vary greatly in an unvulcanized puncture sealant-containing tire. Generally, the thickness of the sealant composition layer may range from about 0.13 cm (0.05 inches) to about 1.9 cm (0.75 inches). In passenger tires it is normally desired for the sealant composition layer to have a thickness of about 0.32 cm (0.125 inches) whereas for truck tires, a thickness of about 0.76 cm (0.25 inches) or greater might be desired.

After the unvulcanized pneumatic rubber tires of this invention are assembled they are vulcanized using a normal tire cure cycle. The tires of this invention can be cured over a wide temperature range. For example, passenger tires might be cured at a temperature ranging from about 130° C. to about 170° C. and truck tires might be cured at a temperature ranging from about 130° C. to about 170° C. Thus, a cure temperature may range, for example, from about 130° C. to about 170° C. and for a period of time (e.g. from about 10 to about 45 minutes or more depending somewhat upon the size of the tire and the degree of desired depolymerization of the butyl rubber as well as the thickness of the sealant layer itself) and sufficient to at least partially depolymerize said sealant precursor layer to the aforesaid storage modulus (G′) physical property. In practice, a period of time used to vulcanize the tires, in a suitable mold, may therefore, for example, have a duration of about 10 to 14 minutes for a passenger tire and for about 25 to about 55 minutes for a truck tire.

While certain representative embodiments and details have been shown for the purpose of illustrating the invention, it will be appreciated there is still in the art various changes and modifications may be made therein without departing from the spirit or scope of the invention.

What is claimed is:

1. A method of making a tire with a built in sealant comprising the steps of:
mounting an inner liner onto a tire building drum, extruding a sealant composition into strips having tapered sidewalls, cutting the strip to a desired length, mounting the sealant over the inner liner, layering a tire component over the sealant.

2. The method of claim 1 wherein the sealant has a width in the range of about 6 to about 10 inches.

3. The method of claim 1 wherein the sealant is colored.

4. The method of claim 1 wherein the sealant is comprised of, based upon parts by weight per 100 parts by weight of said partially depolymerized butyl rubber exclusive of carbon black:
(A) a partially organoperoxide-depolymerized butyl rubber as a copolymer of isobutylene and isoprene, wherein said butyl rubber, prior to such depolymerization, is comprised of about 0.5 to about 5 percent units derived from isoprene, and correspondingly from about 95 to about 99.5 weight percent units derived from isobutylene;
(B) particulate reinforcing filler comprised of:
(1) about 20 to about 50 phr of synthetic amorphous silica, or
(2) about 15 to about 30 phr synthetic amorphous silica, preferably precipitated silica, and about 5 to about 20 phr of clay, or
(3) about 15 to about 30 phr synthetic amorphous silica and about 5 to about 20 phr of calcium carbonate, or
(4) about 15 to about 30 phr synthetic amorphous silica, about 5 to about 15 phr of clay and about 5 to about 15 phr of calcium carbonate;
(C) from zero to 6 phr of short organic fibers;
(D) a colorant of other than a black color wherein said colorant is selected from at least one of organic pigments, inorganic pigments and dyes; and
(E) from zero to about 20 phr of rubber processing oil.
